(19) United States
(12) Patent Application Publication
(10) Pub. No.: US 2020/0192457 A1
(43) Pub. Date: Jun. 18, 2020

(54) POWER-SAVING PROCESSING METHOD AND DEVICE, MOBILE TERMINAL AND COMPUTER-READABLE STORAGE MEDIUM

(71) Applicant: ZTE CORPORATION, Shenzhen, Guangdong (CN)

(72) Inventor: Baisheng ZHANG, Shenzhen, Guangdong (CN)

(21) Appl. No.: 16/633,208

(22) PCT Filed: Aug. 3, 2018
(86) PCT No.: PCT/CN2018/098611

§ 371 Date: Jan. 23, 2020

(30) Foreign Application Priority Data
Aug. 4, 2017 (CN) 201710659599.3

(51) Int. Cl. G06F 1/3209; G06F 1/329; G06F 1/3234; H04W 52/02

(52) U.S. Cl. CPC G06F 1/3209; H04W 52/0274; G06F 1/3243; G06F 1/329

(57) ABSTRACT

The present disclosure discloses a power-saving processing method and device, a mobile terminal and a computer-readable storage medium. The method includes: obtaining, by an obtaining module, network information of a target application; establishing, by an establishing module, a filtering rule according to the network information; and filtering, by a communication module, received data according to the filtering rule to reduce a frequency at which a system is woken up from a low power consumption state when the system is in the low power consumption state.

### TECHNICAL FIELD

The present disclosure relates to the field of communication technologies, and particularly to a power-saving processing method and device, a mobile terminal and a computer-readable storage medium.

### BACKGROUND

In order to reduce the power consumption, a system of the terminal will enter a low power consumption state when the terminal is idle. But the terminal has a lot of background applications which remain connected to a server through a network, so the server may often send data packets to the terminal even if the system is in the low power consumption state. A communication module of the terminal wakes up the system after receiving the data packets, thus cause the system to be woken up frequently, which increases the power consumption of the terminal and reduces standby time of the terminal.

Therefore, how to reduce the frequency at which the system is woken up in the low power consumption state to save the power of the terminal is a problem needs to be solved urgently.

### SUMMARY

According to an aspect of the present disclosure, a power-saving processing method is provided, which includes: obtaining, by an obtaining module, network information of a target application; establishing, by an establishing module, a filtering rule according to the network information; and filtering, by a communication module, received data according to the filtering rule to reduce a frequency at which a system is woken up from a low power consumption state when the system is in the low power consumption state.

According to another aspect of the present disclosure, a power-saving processing device is provided, which includes: an obtaining module configured to obtain network information of a target application; an establishing module configured to establish a filtering rule according to the network information; and a communication module configured to filter received data according to the filtering rule to reduce a frequency at which a system is woken up from a low power consumption state when the system is in the low power consumption state.

According to yet another aspect of the present disclosure, a mobile terminal is provided, which includes a memory, a processor, and at least one application stored in the memory, when the at least one application is executed by the processor, the processor performs the power-saving processing method described above.

According to still another aspect of the present disclosure, a computer-readable storage medium is provided, which stores the power-saving processing program that, when executed by a processor, cause the processor to perform the steps of the power-saving processing method described above.

### BRIEF DESCRIPTION OF DRAWINGS

FIG. 1 is a flow chart of a power-saving processing method according to an embodiment of the present disclosure.

FIG. 2 is a mapping table of target applications and network information according to an embodiment of the present disclosure.

FIG. 3 is a module schematic diagram of a power-saving processing device according to an embodiment of the present disclosure.

FIG. 4 is a module schematic diagram of an obtaining module in the power-saving processing device.

FIG. 5 is a module schematic diagram of a communication module in the power-saving processing device.

The implementation of the purpose, the functional characteristics and the advantages of the present disclosure will be further illustrated in combination with the embodiments and with reference to the drawings.

### DETAILED DESCRIPTION

In order to make the technical problems to be solved, technical solutions and beneficial effects of the present disclosure more explicit and clearer, the present disclosure will be further illustrated below in details in combination with the drawings and the embodiments. It should be understood that specific embodiments described herein are only used to explain but not limit the present disclosure.

Referring to FIG. 1, a power-saving processing method is provided, which includes the following steps S11-S13.

In step S11, an obtaining module obtains network information of a target application.

Specifically, the obtaining module may firstly obtain a target application list including at least one target application. When the target application is in a network connection state, the obtaining module may further obtain network information of each target application in the target application list. For the target applications selected into the target application list, when the system is in a low power consumption state, data sent by the network side for these target applications may be discarded or received with a delay, to avoid waking up the system or reduce the frequency of waking up the system, so that the system stays in the low power consumption state and saves the terminal's power. It can be understood that the system may be a system of the terminal.

In an embodiment of the present disclosure, the obtaining module may obtain the target application list in various ways.

For example, the obtaining module may obtain the target application list from outside, e.g., download the target application list from the network.

In another example, the obtaining module may provide a program list setting interface, so that a user may customize the target application list on the program list setting interface.

In one embodiment, the obtaining module may count power consumption and/or usage frequency of each application in the terminal, select the applications with high power consumption and/or low usage frequency as the target applications, and generate the target application list according to the selected target applications. When identifying the applications with high power consumption and/or low usage frequency, the obtaining module may identify the applications with power consumption higher than a first threshold and/or usage frequency lower than a second threshold as the applications with high power consumption and/or low usage frequency; or may sort all the applications according to an order of power consumption from high to low and/or an order of usage frequency from low to high, and identify the applications sorted in the top N (N≥1) as the applications with high power consumption and/or low usage frequency. The first threshold and the second threshold may be set according to actual demands.

For example, the obtaining module may periodically detect the power consumption (such as electricity consumption) of each application on the terminal and the frequency at which the application is used by the user, and sort each application by use of the power consumption and the usage frequency, where the applications with higher power consumption and lower usage frequency are sorted before the applications with lower power consumption and higher usage frequency. Then the obtaining module selects the applications sorted in the top N (e.g., the top 5) as the target applications, and generates a target application list according to the selected target applications. The obtaining module may periodically update the target application list and periodically output the target application list. In one embodiment, the user may also modify the application list, for example, may adjust the order of applications in the list, delete an application from the list, add an application to the list, and so on.

When the terminal accesses the network through a communication module, each application in the terminal may establish a network connection with its remote server or peer, and the corresponding network system may assign a source IP address, a destination IP address, network ports (source port, destination port), protocol and others for this connection. For example, when a TCP connection is established, the source IP address assigned by the network for this is 202.118.45.7, the destination IP address is 202.118.48.8, an occupied destination port is 8899, and a used protocol is TCP. The obtaining module may obtain the network information of each target application in the target application list. The network information includes at least one of the source IP address, the destination IP address, the source port, the destination port and the protocol type used by the target application.

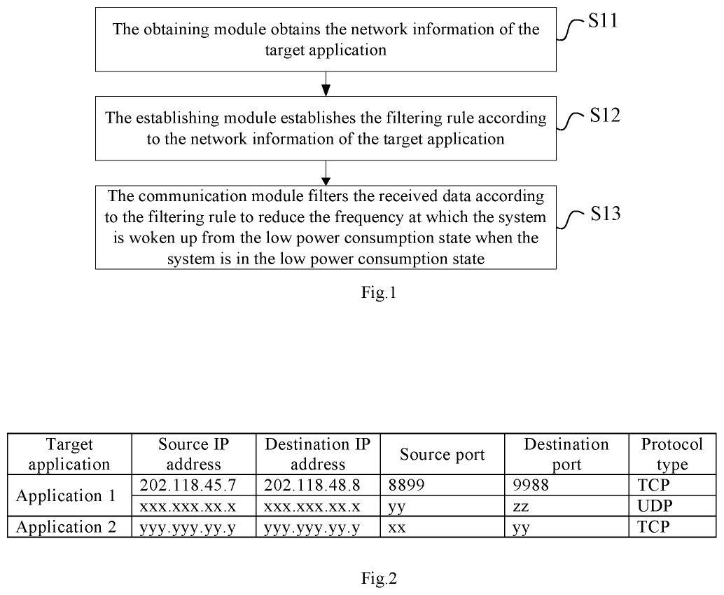

As shown in FIG. 2, the obtaining module may establish a mapping table between the target applications and network information. Generally, each target application corresponds to a set of network information. In addition, some target applications may further correspond to two or even more sets of network information, where each set of network information includes at least one of the source IP address, the destination IP address, the source port, the destination port and the protocol type. For example, the application 1 corresponds to two sets of network information in FIG. 2, where a set of network information is as follows: the source IP address is 202.118.45.7, the destination IP address is 202.118.48.8, the source port is 8899, the destination port is 9988, and the protocol type is TCP.

The aforementioned communication module may be the Wireless Local Area Network (WLAN) module, modem module, Bluetooth module, or the like.

In step S12, an establishing module establishes a filtering rule according to the network information of the target application.

Specifically, the establishing module may analyze and arrange the network information of the target application to formulate a corresponding filtering rule, convert the filtering rule into a language that the communication module can execute, such as Berkeley Packet Filter (BPF) language, and configure it into the communication module. The filtering rule includes at least one of rules such as discarding data with preset network information, delaying in receiving data with preset network information and others, where the data is data sent by the network side to the target application. The delayed reception may be to receive once after delaying for a certain preset time (e.g., periodic reception) or receive once after delaying for a preset number of data packets (e.g., receive once each time when five data packets are accumulated), where the reception means that the system receives data sent by the network side.

In one embodiment, the preset network information may include at least one of all pieces of information included in the network information of the target application.

For example, the filtering rule may be set as: discarding (or filtering out) data of which the source IP address is 222.118.45.7, the destination port is 9988 and the protocol type is TCP (or TCP data packet); discarding data of which the destination port is 4567 and the protocol type is TCP; and delaying in receiving data of which the source address is 202.118.45.7 and the protocol type is UDP (or UDP data packet).

In one embodiment, the establishing module may formulate different filtering rules according to a ranking of each target application in the target application list. For example, for the target application ranking the first (i.e., the target application with the highest power and/or lowest usage rate), all data of the target application may be filtered out; while for the target application ranking lower, some data of the target application may be received periodically.

According to the above-mentioned filtering rule, when the system works normally, the target application may transmit data over the network; when the system is in the low power consumption state, the communication module may process data of the target application according to the filtering rule, to prohibit the target application from transmitting data or to reduce the number of times the target application transmits data, thereby ensuring that the system is in the low power state to the greatest extent, reducing the system power consumption, and saving the terminal power.

In step S13, the communication module filters received data according to the filtering rule to reduce a frequency at which the system is woken up from the low power consumption state when the system is in the low power consumption state.

The low power consumption state described in the embodiments of the present disclosure may be a sleep state, a power-saving mode state, a standby state, or other state in which the system runs at lower power consumption. When the system is in the low power consumption state, the communication module remains connected to the network side and receives data sent by the network side. The communication module may obtain the network information of the data and determine whether the data conforms to the filtering rule according to the network information. When the data conforms to the filtering rule, the data may be processed according to the filtering rule, for example, the data may be directly filtered out (e.g., discarded) or may be sent to the system with a delay. By using the filtering rule to filter the data, it is possible to filter out the unimportant or useless information sent by the network side to the target application, thereby reducing the frequency at which the system is woken up from the low power state and keeping the system in the low power consumption state as possible.

For example, when the network information of the data is “the destination port is 4567 and the protocol type is TCP”, the communication module may determine that the data conforms to the filtering rule of “discarding the data of which the destination port is 4567 and the protocol type is TCP”, and thus may discard the data directly without sending the data to the system to cause the system to be woken up and keep the system in the low power consumption state. When the network information of the data is “the source address is 202.118.45.7 and the protocol type is UDP”, the communication module may determine that the data conforms to the filtering rule of “delaying in receiving the data of which the source address is 202.118.45.7 and the protocol type is UDP”, and thus may send the data to the system periodically or send the data to the system every time when a preset amount of such data is accumulated, thereby reducing the number of times the system is woken up.

When the data does not conform to the filtering rule, the communication module may send the data to a corresponding application in the system, or may perform other processing, which is not limited in the present disclosure.

According to the power-saving processing method of the embodiments of the present disclosure, the filtering rule may be established according to the network information of the target application, and when the system is in the low power consumption state, the received data may be filtered according to the filtering rule to reduce the frequency at which the system is woken up from the low power consumption state and keep the system in the low power consumption state as possible, so as to avoid the unimportant or useless data sent by the network side to the target application from waking up the system from the low power consumption state. This reduces the frequency at which the system is woken up, thereby reducing the power consumption of the system, saving the power of the terminal, and extending the standby time of the terminal.

The power-saving processing method according to the embodiments of the present disclosure may be applied to a mobile terminal such as mobile phone, tablet or the like. By taking the mobile phone as an example, when the system of the mobile phone is in the sleep state, the communication module of the mobile phone may directly discard unimportant or useless data packets sent by the network side, which greatly reduces the number of times the system is woken up, so that the system is in the sleep state during most of the time, which reduces the electricity consumption of the mobile phone and prolongs the standby time of the mobile phone.

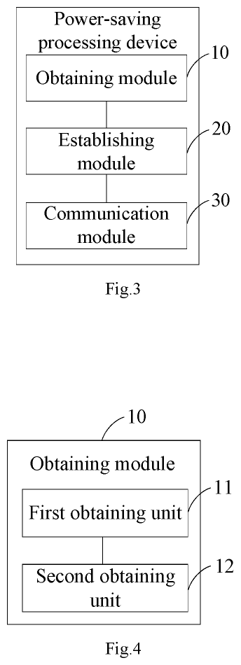

Referring to FIG. 3, a power-saving processing device is provided, which includes an obtaining module 10, an establishing module 20 and a communication module 30.

The obtaining module 10 is configured to obtain network information of a target application.

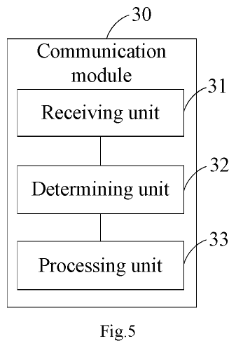

As shown in FIG. 4, the obtaining module 10 includes a first obtaining unit 11 and a second obtaining unit 12. The first obtaining unit 11 is configured to obtain a target application list including at least one target application. The second obtaining unit 12 is configured to obtain the network information of each target application in the target application list when the target application is in a network connection state.

In an embodiment of the present disclosure, the first obtaining unit 11 may obtain the target application list in various ways.

For example, the first obtaining unit 11 may obtain the target application list from outside, e.g., download the target application list from the network.

In another example, the first obtaining unit 11 may provide a program list setting interface, so that a user may customize the target application list on the program list setting interface.

In one embodiment, the first obtaining unit 11 may count power consumption and/or usage frequency of each application in the terminal, select the applications with high power consumption and/or low usage frequency as the target applications, and generate the target application list according to the selected target applications. When identifying the applications with high power consumption and/or low usage frequency, the first obtaining unit 11 may identify the applications with power consumption higher than a first threshold and/or usage frequency lower than a second threshold as the applications with high power consumption and/or low usage frequency; or may sort all the applications according to an order of power consumption from high to low and/or an order of usage frequency from low to high, and identify the applications sorted in the top N (N 1) as the applications with high power consumption and/or low usage frequency. The first threshold and the second threshold may be set according to actual demands.

For example, the first obtaining unit 11 may periodically detect the power consumption (such as electricity consumption) of each application on the terminal and the frequency at which the application is used by the user, and sort each application by use of the power consumption and the usage frequency, where the applications with higher power consumption and lower usage frequency are sorted before the applications with lower power consumption and higher usage frequency. Then the first obtaining unit 11 selects the applications sorted in the top N (e.g., the top 5) as the target applications, and generates a target application list according to the selected target applications. The first obtaining unit 11 may periodically update the target application list and periodically output the target application list. In one embodiment, the user may also modify the application list, for example, may adjust the order of applications in the list, delete an application from the list, add an application to the list, and so on.

When the terminal accesses the network through the communication module 30, each application in the terminal may establish a network connection with its remote server or peer, and the corresponding network system may assign a source IP address, a destination IP address, network ports (source port, destination port), protocol and others for this connection. For example, when a TCP connection is established, the source IP address assigned by the network for this is 202.118.45.7, the destination IP address is 202.118.48.8, an occupied destination port is 8899, and a used protocol is TCP. At this time, the second obtaining unit 12 may obtain the network information of each target application in the target application list. The network information includes at least one of the source IP address, the destination IP address, the source port, the destination port and the protocol type used by the target application.

As shown in FIG. 2, the second obtaining unit 12 may establish a mapping table between the target applications and network information. Generally, each target application corresponds to a set of network information. In addition, some target applications may further correspond to two or even more sets of network information, where each set of network information includes at least one of the source IP address, the destination IP address, the source port, the destination port and the protocol type.

The establishing module 20 is configured to establish a filtering rule according to the network information of the target application.

The establishing module 20 analyzes and arranges the network information of the target application to formulate a corresponding filtering rule, convert the filtering rule into a language that the communication module 30 can execute, such as Berkeley Packet Filter (BPF) language, and configure it into the communication module 30. The filtering rule includes at least one of rules such as discarding data with preset network information, delaying in receiving data with preset network information and others, where the data is data sent by the network side to the target application. The delayed reception may be to receive once after delaying for a certain preset time (e.g., periodic reception) or receive once after delaying for a preset number of data packets (e.g., receive once each time when five data packets are accumulated), where the reception means that the system receives data sent by the network side.

In one embodiment, the preset network information may include at least one of all pieces of information included in the network information of the target application.

For example, the establishing module 20 may set the filtering rule as: discarding (or filtering out) data of which the source IP address is 222.118.45.7, the destination port is 9988 and the protocol type is TCP (or TCP data packet); discarding data of which the destination port is 4567 and the protocol type is TCP; and delaying in receiving data of which the source address is 202.118.45.7 and the protocol type is UDP (or UDP data packet).

In one embodiment, the establishing module 20 may formulate different filtering rules according to a ranking of each target application in the target application list. For example, for the target application ranking the first (i.e., the target application with the highest power and/or lowest usage rate), all data of the target application may be filtered out; while for the target application ranking lower, some data of the target application may be received periodically.

According to the above-mentioned filtering rule, when the system works normally, the target application may transmit data over the network; when the system is in the low power consumption state, the communication module 30 may process data of the target application according to the filtering rule, to prohibit the target application from transmitting data or to reduce the number of times the target application transmits data, thereby ensuring that the system is in the low power state to the greatest extent, reducing the system power consumption, and saving the terminal power.

The communication module 30 is configured to filter received data according to the filtering rule to reduce a frequency at which the system is woken up from the low power consumption state when the system is in the low power consumption state.

The low power consumption state described in the embodiments of the present disclosure may be a sleep state, a power-saving mode state, a standby state, or other state in which the system runs at lower power consumption. When the system is in the low power consumption state, the communication module 30 remains connected to the network side.

As shown in FIG. 5, the communication module 30 includes a receiving unit 31, a determining unit 32 and a processing unit 33, where the receiving unit 31 is configured to receive data and obtain network information of the data when the system is in the low power consumption state; the determining unit 32 is configured to determine whether the data conforms to the filtering rule according to the network information of the data; and the processing unit 33 is configured to process the data according to the filtering rule when the data conforms to the filtering rule, for example, directly filter out (e.g., discard) the data or send the data to the system with a delay. By using the filtering rule to filter the data, it is possible to filter out the unimportant or useless information sent by the network side to the target application, thereby reducing the frequency at which the system is woken up from the low power state and keeping the system in the low power consumption state as possible.

For example, when the network information of the data is “the destination port is 4567 and the protocol type is TCP”, the determining unit 32 may determine that the data conforms to the filtering rule of “discarding the data of which the destination port is 4567 and the protocol type is TCP”, so the processing unit 33 may discard the data directly without sending the data to the system to cause the system to be woken up, to keep the system in the low power consumption state. When the network information of the data is “the source address is 202.118.45.7 and the protocol type is UDP”, the determining unit 32 may determine that the data conforms to the filtering rule of “delaying in receiving the data of which the source address is 202.118.45.7 and the protocol type is UDP”, so the processing unit 33 may send the data to the system periodically or send the data to the system every time when a preset amount of such data is accumulated, thereby reducing the number of times the system is woken up.

When the data does not conform to the filtering rule, the processing unit 33 may send the data to a corresponding application in the system, or may perform other processing, which is not limited in the present disclosure.

The communication module 30 described in the embodiments of the present disclosure may be the WLAN module, modem module, Bluetooth module, or the like.

According to the power-saving processing device of the embodiments of the present disclosure, the filtering rule may be established according to the network information of the target application, and when the system is in the low power consumption state, the received data may be filtered according to the filtering rule to reduce the frequency at which the system is woken up from the low power consumption state and keep the system in the low power consumption state as possible, so as to avoid the unimportant or useless data sent by the network side to the target application from waking up the system from the low power consumption state. This reduces the frequency at which the system is woken up, thereby reducing the power consumption of the system, saving the power of the terminal, and extending the standby time of the terminal.

The power-saving processing method and device according to the embodiments of the present disclosure may be applied to a mobile terminal such as mobile phone, tablet or the like, or may be applied to a fixed terminal such as personal computer or the like.

An embodiment of the present disclosure further provides a mobile terminal, which includes a memory, a processor, and at least one application stored in the memory and configured to be executed by the processor, where the application is configured to perform a power-saving processing method. The power-saving processing method includes the following steps: an obtaining module obtains network information of a target application; an establishing module establishes a filtering rule according to the network information; and a communication module filters received data according to the filtering rule to reduce a frequency at which the system is woken up from the low power consumption state when the system is in the low power consumption state. For the details of the steps of the power-saving processing method, the reference may be made to the power-saving processing method described above in combination with FIGS. 1 and 2, and the detailed description thereof will be omitted here.

An embodiment of the present disclosure further provides a computer-readable storage medium, which stores the power-saving processing program that performs the steps of a power-saving processing method when executed by a processor. The power-saving processing method includes the following steps: an obtaining module obtains network information of a target application; an establishing module establishes a filtering rule according to the network information; and a communication module filters received data according to the filtering rule to reduce a frequency at which the system is woken up from the low power consumption state when the system is in the low power consumption state. For the details of the steps of the power-saving processing method described in this embodiment, the reference may be made to the power-saving processing method described above in combination with FIGS. 1 and 2, and the detailed description thereof will be omitted here.

It may be clearly understood by those skilled in the art that the power-saving processing method described in each above embodiment may be implemented by means of software plus a necessary general-purpose hardware platform. Of course, the power-saving processing method may also be implemented by means of hardware. Based on such understanding, the essential part or the part contributing to the prior art in the technical solution of the present disclosure may be embodied in a form of software product. The computer software product is stored in a storage medium (such as ROM/RAM, disk, compact disc), and includes several instructions used to enable a terminal device (which may be a mobile phone, a computer, a server, an air conditioner, a network equipment or the like) to perform the power-saving processing method described in each embodiment of the present disclosure.

It should be understood that the above embodiments are merely exemplary embodiments of the present disclosure, and not intended to limit the scope of the present disclosure. Any equivalent structural transformation or equivalent process transformation made according to the content of the specification and drawings of the present disclosure, or the direct or indirect use of the content in other related technical fields is included in the protection scope of the present disclosure.

1. A power-saving processing method, comprising:
obtaining, by an obtaining module, network information of a target application;
establishing, by an establishing module, a filtering rule according to the network information; and
filtering, by a communication module, received data according to the filtering rule to reduce a frequency at which a system is woken up from a low power consumption state when the system is in the low power consumption state.

2. The power-saving processing method according to claim 1, wherein the step of filtering, by the communication module, the received data according to the filtering rule comprises:
receiving data and obtaining network information of the data;
determining whether the data conforms to the filtering rule according to the network information of the data; and
processing the data according to the filtering rule when the data conforms to the filtering rule.

3. The power-saving processing method according to claim 1, wherein the step of obtaining, by the obtaining module, the network information of the target application comprises:
obtaining a target application list comprising at least one target application; and
obtaining network information of each target application in the target application list when the target application is in a network connection state.

4. The power-saving processing method according to claim 3, wherein the step of obtaining, by the obtaining module, the target application list comprises:
counting power consumption of each application in a terminal; and
selecting applications with high power consumption as the target applications, and generating the target application list according to the selected target applications.

5. The power-saving processing method according to claim 4, wherein the step of selecting the applications with high power consumption as the target applications comprises:
sorting all applications according to an order of power consumption from high to low; and
identifying applications sorted in the top N as the applications with high power consumption, and selecting these N applications as the target applications, wherein N≥1.

6. The power-saving processing method according to claim 4, wherein the step of selecting the applications with high power consumption as the target applications comprises:
identifying applications with power consumption higher than a first threshold as the applications with high power consumption, and selecting these applications as the target applications.

7. The power-saving processing method according to claim 3, wherein the step of obtaining, by the obtaining module, the target application list comprises:
counting a usage frequency of each application in a terminal; and
selecting applications with low usage frequency as target applications, and generating the target application list according to the selected target applications.

8. The power-saving processing method according to claim 7, wherein the step of selecting the applications with low usage frequency as the target applications comprises:
sorting all applications according to an order of usage frequency from low to high; and
identifying applications sorted in the top N as the applications with low usage frequency, and selecting these N applications as the target applications, wherein N≥1.

9. The power-saving processing method according to claim 7, wherein the step of selecting the applications with low usage frequency as the target applications comprises:
identifying applications with usage frequency lower than a second threshold as the applications with low usage frequency, and selecting these applications as the target applications.

10. The power-saving processing method according to claim 1, wherein the network information comprises at least one of a source IP address, a destination IP address, a source port, a destination port and a protocol type.

11. The power-saving processing method according to claim 1, wherein the filtering rule comprises at least one of:
discarding data with preset network information; and
delaying in receiving data with preset network information.

12. The power-saving processing method according to claim 11, wherein the preset network information comprises at least one of all pieces of information comprised in the network information of the target application.

13. A power-saving processing device, comprising:
an obtaining module configured to obtain network information of a target application;
an establishing module configured to establish a filtering rule according to the network information; and
a communication module configured to filter received data according to the filtering rule to reduce a frequency at which a system is woken up from a low power consumption state when the system is in the low power consumption state.

14. A mobile terminal comprising a memory, a processor, and at least one application stored in the memory, when the at least one application is executed by the processor, the processor performs a power-saving processing method comprsing:
obtaining, by an obtaining module, network information of a target application;
establishing, by an establishing module, a filtering rule according to the network information, and
filtering, by a communication module, received data according to the filtering rule to reduce a frequency at which a system is woken up from a low power consumption state when the system is in the low power consumption state.

15. A computer-readable storage medium storing a power-saving processing program which, when executed by a processor, cause the processor to perform the steps of the power-saving processing method of claim 1.
